(19) United States
(12) Patent Application Publication
(10) Pub. No.: US 2015/0301706 A1
(43) Pub. Date: Oct. 22, 2015

(54) IDENTIFIABLE TABBING FOR BOOKMARKS IN ELECTRONIC BOOKS

(71) Applicants: Mark Alan LOGAN, Beech Grove, IN (US); Chad Andrew FEVRE, Indianapolis, IN (US); THOMSON LICENSING, Issy les Moulineaux (FR)

(72) Inventors: Mark Alan LOGAN, Beech Grove, IN (US); Chad Andrew LE-FEVRE, Indianapolis, IN (US)

(73) Assignee: Thomson Licensing, Issy de Moulineaux (FR)

(21) Appl. No.: 14/648,927

(22) PCT Filed: Dec. 20, 2012
(86) PCT No.: PCT/US2012/070841

§ 371 Date: Jun. 2, 2015

(51) Int. Cl. G06F 3/0483; G06F 17/30; G06F 3/0481

(52) U.S. Cl. CPC G06F 3/0483; G06F 3/0481; G06F 17/30973

(57) ABSTRACT

Methods and apparatus for tabbing electronic documents such as e-books allows users to associate selected content in an electronic document with tabs that can be displayed and organized in a versatile manner, including grouping tabs with different colors, each color corresponding to a different category, e.g., a different character in a story, selecting some colors to display, selecting display of tabs added by other readers, adding metadata to each tab indicating selected content, highlighting selected content, and/or condensing the electronic document to include only content associated with selected tabs.

### FIELD OF THE DISCLOSURE

The present invention generally relates to electronic document methods and apparatus.

### BACKGROUND INFORMATION

With paper documents such as books, when bookmarking pages, pieces of paper, adhesive-backed tabs, or the like, are commonly used. In addition to positional information, such marks can convey additional information by the addition of comments or notes on the paper and/or the use of paper of different colors. Electronic books (or e-books) or e-book readers, however, do not provide a similar capability, and are limited, for example, to such features as the addition of bookmarks and text highlighting. Moreover, e-book readers do not allow much, if any, ability to manage tabs and their associated content.

### SUMMARY OF THE DISCLOSURE

Exemplary methods and apparatus are disclosed for annotating electronic documents, such as e-books, which introduce features heretofore not available with other electronic document presentation methods and apparatus.

In exemplary embodiments, color tabs are added to an e-book as part of the visual display of the book. The tabs allow new bookmarking features to be added, including book organization, multiple tab viewing modes and content condensing features.

Exemplary embodiments of the disclosure allow users to associate tabs with any selected content, including, for example, chapters, pages, paragraphs, or words, and to add supplemental information describing the associated content. Tabs are visible at the edge of the e-book and can be placed anywhere in the e-book, including the top, bottom, right, and left. Tabs can be associated with a given page or a user-selectable set of pages.

Exemplary embodiments allow a user to view all tabs at once or selectively view only subsets of tabs, such as tabs of a certain color or icon, for example. The user can selectively view only the content associated with the selected tabs.

Many e-books, whether text books, reference books, history books, or sci-fi fantasy books, often require a reader to refer to more than one page for content while reading, including for example, references to pictures, tables, maps, and footnotes. Exemplary embodiments of the present disclosure readily allow referencing of those elements while reading. In addition, book organization may not be optimal in terms of finding certain pieces of information quickly. Exemplary embodiments allow easy book re-arranging and condensing.

In view of the above, and as will be apparent from the detailed description, other embodiments and features are also possible and fall within the principles of the disclosure.

### BRIEF DESCRIPTION OF THE DRAWINGS

Some embodiments of apparatus and/or methods in accordance with embodiments of the present disclosure are now described, by way of example only, and with reference to the accompanying figures in which:

FIG. 1 is a schematic diagram depicting an exemplary electronically stored document, such as an e-book, displayed in a single-page mode according to an aspect of the present disclosure.

FIG. 2 is a schematic diagram depicting the exemplary electronically stored document displayed in a two-page mode according to an aspect of the present disclosure.

FIG. 3 is a schematic diagram depicting an illustrative grid mode view of tabs and associated information in the exemplary electronically stored document of FIGS. 1 and 2.

FIG. 4 is a flow diagram depicting representative steps for generating tabs for an electronically stored document according to an aspect of the present disclosure.

FIG. 5 is a schematic diagram depicting a representative computer system for implementing exemplary methods and systems for generating and managing tabs associated with an electronically stored document according to an aspect of the present disclosure.

The illustrative embodiments are described more fully by the figures and detailed description. The inventions may, however, be embodied in various forms and are not limited to specific embodiments described in the Figures and detailed description

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative apparatus embodying principles of the disclosure. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

The functions of the various elements shown in the figures, including any functional blocks labeled “processors,” may be provided through the use of dedicated hardware as well as hardware capable of executing software in association with appropriate software. When provided with a processor, the functions may be provided with a single dedicated processor, a single shared processor, or a plurality of individual processors, some of which may be shared. Moreover, explicit use of the term “processor” or “controller” should not be construed to refer exclusively to hardware capable of executing software, and may implicitly include, without limitation, one or more of a digital signal processor (DSP), network processor, application specific integrated circuit (ASIC), field programmable gate array (FPGA), read-only memory (ROM), random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

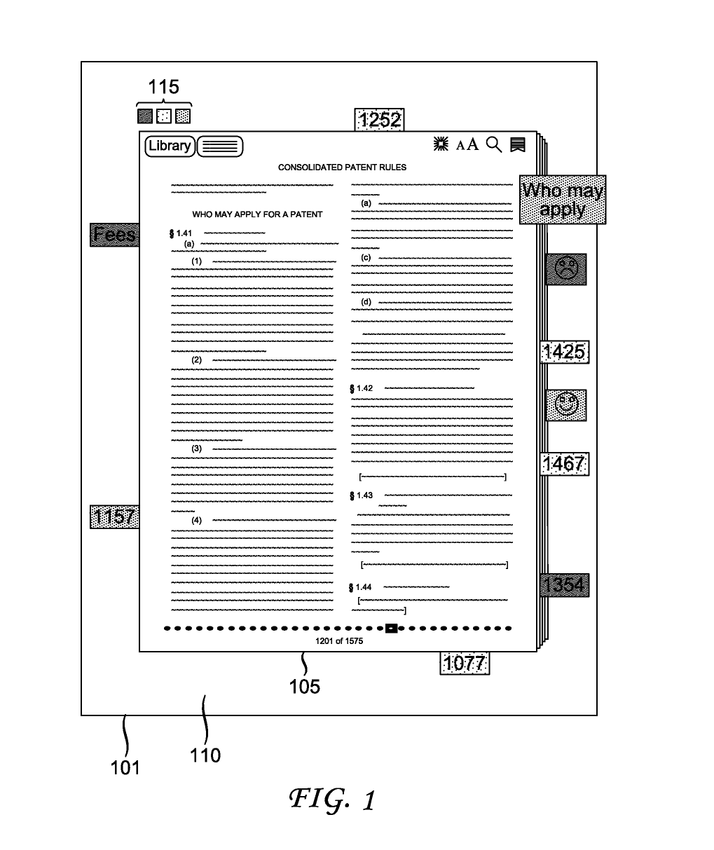

With reference to FIG. 1, there is shown a schematic representation of an illustrative electronically stored document, in particular an e-book, displayed on a display 101 associated with a computer system implementing an exemplary tab feature in accordance with an aspect of the present disclosure. The e-book is shown in FIG. 1 in a single-page display mode within a window 105. Window 105 is preferably smaller than the display area of display 101 so as to allow for an expansion area 110 around the edge of the book. Expansion area 110 allows for the placement and display of tabs therein and can be provided on any side of the book in which tabs are displayed; i.e., left, right, top and/or bottom. If there are no tabs to display, or the display of tabs has been disabled, expansion area 110 can be eliminated and window 105 enlarged.

As illustrated, tabs are displayed in three colors, blue, red and yellow, although any suitable colors or shades of colors capable of display can be used. The term “color” as used herein is also intended to include black, white and grayscale. Coloring tabs provides a way to group or categorize tabs. The tabs can be grouped in accordance with a variety of characteristics, including, for example, subject matter, importance, user, or date/time generated, among other possibilities.

In the illustration of FIG. 1, multiple pages are tabbed and the tabs appear to project from the pages that are tabbed. For most of the tabs shown, the only information on the tabs is location information, such as page number. Other location information may include chapter, section, heading, paragraph, column and/or row, and line number. However, other information can also be displayed, including, for example, headings, short notes, keywords, icons, or images, among other possibilities. For example, as shown, the current page (1201) includes a blue tab with the notation “Who may apply,” which in this illustration corresponds to subject matter on the page. As illustrated, the tab with notation “Fees,” the tab with a sad smiley, and the tab with a page number of 1354 are in red; the tab a page number of 1157, the tab with the notation “Who may apply,” and the tab with a happy smiley are in blue; and the tabs respectively with page numbers of 1252, 1425, 1467, and 1077 are yellow. Such notations can be automatically generated or entered by a user. The user may also be able to select and/or edit information on the tabs. Furthermore, the display portion of the tab may be further expanded, such as by opening a window to display additional information.

In the illustration of FIG. 1, tabs are shown on the left side of the page. This feature shows tabs located on pages that are behind the current page, in this case, page 1157 and another page with information about fees. As the book is paged backwards, such tabs may flip to be on the current page, now shown on the right side. In one embodiment, these tabs can be shown for pages behind the current page as tabs on the left side, with tabs moving to a proper location and orientation when the respective page is passed.

In the exemplary embodiment illustrated, color-coded elements 115 (red, yellow, and blue from left to right) are provided to allow the user to select, by color, subsets of tabs for display. Thus, responsive to a suitable user action such as tapping one of the colored elements 115, the display will be updated to display tabs of the respective color. A further user action, such as double-tapping a colored element 115, will cause tabs of the respective color to be removed from display. The number of elements 115 provided will depend on the number of different colors used for the tabs.

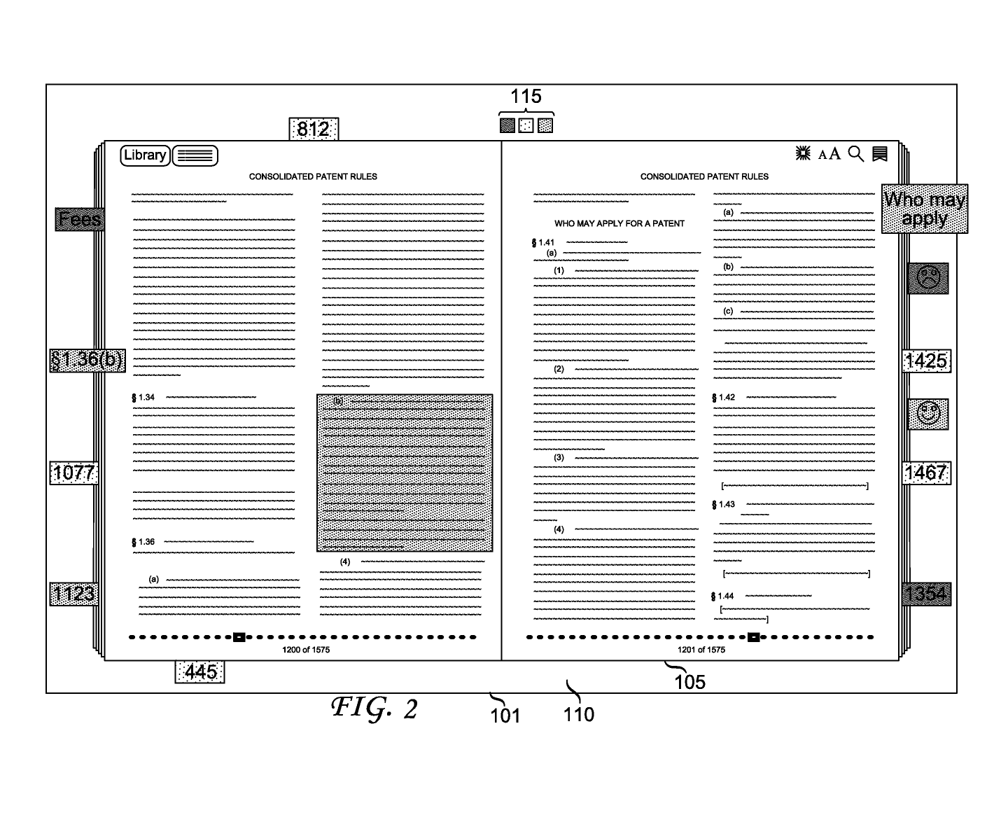

FIG. 2 shows an exemplary e-book in a two-page mode. Tabs (colored yellow, red and blue) are clearly visible on all sides for portions of the book for the current pages as well as pages preceding and following the current page. The tabs respectively with “Fees,” a sad smiley, a page number of 1354 are in red; the tabs respectively with “§1.36(b),” a page number of 1123, a page number of 812, a happy smiley, and “Who may apply” are in blue; and the other tabs are in yellow.

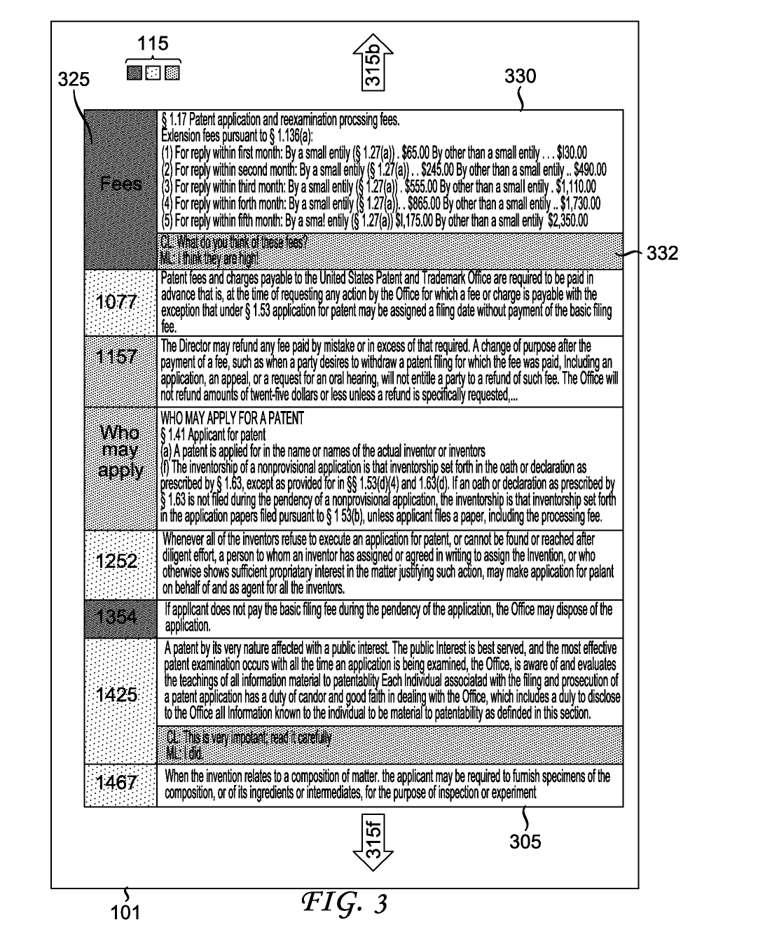

In exemplary embodiments, a “pocket guide” feature is implemented in which a display is created to view tabbed elements and the contents associated with the tabs (highlights or text content) as a grid or table, such as illustrated in FIG. 3. As shown in FIG. 3, when a pocket guide mode has been invoked, a table 305 is displayed on display 101. Table 305 includes a plurality of entries, one for each of a plurality of tabs in the e-book. Depending on the number of tabs in the e-book, all or a subset of the tabs are displayed at one time. If not all tabs in the e-book can be displayed at the same time, elements 315b and 315f can be used to navigate backwards and forwards, respectively, through the tabs in the e-book.

As shown in FIG. 3, for each tab 325, table 305 includes an area 330 which displays information associated with the tab. In the table illustrated in FIG. 3, area 330 includes all or a portion of the e-book content with which the tab is associated. Optionally, area 330 includes a portion 332 containing notes or comments added by one or more users, which users, preferably optionally, can be identified, in this case by their initials “CL” and “ML.”

Each tab 325 is displayed with the same text and/or color as displayed in the e-book display modes of FIGS. 1 and 2. As in the modes illustrated in FIGS. 1 and 2, color-coded elements 115 are provided to allow the user to select, by color, subsets of tabs for inclusion in table 305. Thus, by tapping the yellow element 115, for example, table 305 will be updated to display the yellow tabs 325 and their associated areas 330. Double tapping the yellow element will cause the yellow tabs to be removed from the table 330.

The e-book display modes, such as those of FIGS. 1 and 2, may also be modified to show only the tabbed portions thereof, thereby allowing a condensed version of the book to be created and displayed (e.g., so that a book of several hundred pages can be condensed to a page or two of content and/or supplementary information such as user notes). Thus, for example, if there are tabs associated with content relating to a particular character in an e-book, an abbreviated version of the e-book can be displayed in which only said content is displayed by selecting those tabs.

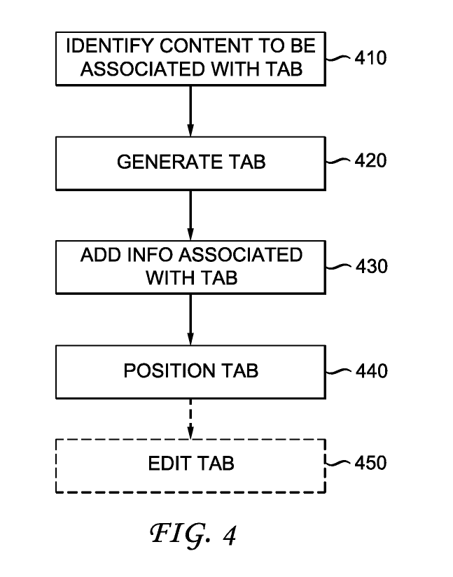

FIG. 4 shows a flowchart of an exemplary embodiment of a method of providing tabs in an e-book. At step 410, content in the e-book to be associated with a tab to be generated is identified. The content may include, for example, one or more chapters, pages, paragraphs, sentences, words, images, or any suitable grouping of content. The content may be identified automatically, or by a user such as by use of a highlighting function. For example, in the illustration of FIG. 2, a user has highlighted the text of paragraph b of 37 CFR §1.36.

Once the content to be associated with the new tab has been identified, operation then proceeds to step 420 in which the new tab is generated. This can be done in response to a suitable user action such as a touchscreen gesture or voice command.

Once the tab has been generated, information to be associated with the tab is then added at step 430. The information can be automatically generated or user generated and may include, for example, page number, heading, one or more keywords, a short description, and/or a hyperlink (to a website, another book, or other content), among other possibilities.

At step 440, the tab is displayed in expansion area 110, preferably at a location proximate to the content with which it is associated. Preferably, the user is allowed to position/re-position the tab on the page or on a different page. If there are multiple tabs to be displayed, they can be automatically positioned so as to avoid or minimize any overlap, thereby allowing optimal display of the tabs. Preferably, tab positioning scales with font size.

Once a tab has been generated, the user is preferably provided the option to edit the tab, including deleting the tab, as represented by step 450. An editing procedure can be initiated, for example, in response to a suitable user action. Editing functions may include, for example, deleting, linking, changing color codes, moving, copying, and pasting, among other possibilities.

In exemplary operation, a user can rapidly move within an e-book to a tabbed portion thereof by, for example, tapping once on a tab. If the tab is associated with a particular portion of content on a page, that portion is preferably highlighted when the page is displayed. If, for example, the user holds his finger over a tab for at least some predetermined time period, any additional information associated with the tab will be displayed. If the user double-taps on the tab, an editing window is opened.

In exemplary embodiments, tabs can be color coded for one or more purposes. For example, colors may be associated with users and/or content. Additionally, a tab may have more than one color. In an exemplary embodiment, a first portion of a tab may have a first color that is associated with a particular user, and a second portion of the tab may have a second color that is associated with content. The color associations can be automatic or user-selectable. Thus, for example, a user can be associated with the color blue and content relating to financial information can be associated with the color green.

In exemplary embodiments, tabs may be interactive, such as by prompting the user for some form of a response or interaction. For example, a tab may pose questions to the user such as “what do you think of this?” The user's response, which can preferably be of any of a variety of forms that the system can capture including audiovisual, can be associated with the tab so that when the tab is accessed again, the user's response can be provided or played.

In exemplary embodiments, all or one or more subsets of tabs can be displayed. For example, tabs can be displayed based on color, association with a user, or in accordance with subject matter. Thus for example, a user can select for display those tabs placed by him of a particular color or those that relate to a particular character in the book.

In exemplary embodiments, a book can be tabbed by more than one user for instance, in either a share me/lend me mode or in accordance with some other arrangement. In this case, one user can access and view the tabs of a different user.

In exemplary embodiments, tabbing can be transferred between e-readers, such as for example, from one copy of a book to another copy of the book. Such a feature can be particular useful, for example, in a classroom setting, in which tabs in a teacher's copy of a textbook can be transferred to students' copies of the textbook. The tabbing function represents metadata for the e-book. This metadata can be transferred independently of the transfer of the book. Each user may need to have a license to the book.

In exemplary embodiments, a tab location search feature is implemented so that when a user performs an input action, such as a double tap on a tab, a window showing the content of the current tab is displayed, in addition to that of one or more tabs forward and/or behind the current tab. The text around the tab location may also be displayed. The tab information and/or text information may be displayed in a grid display, such as that of FIG. 3. A user can use an input action to select an entry, or alternatively move to another set of tabs.

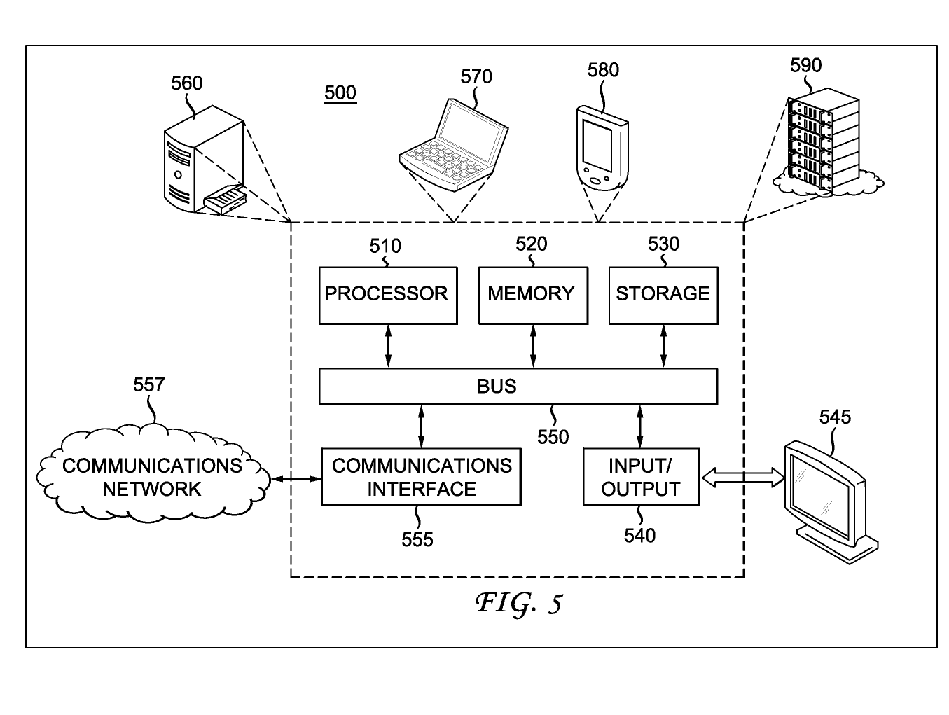

FIG. 5 shows an illustrative computer system 500 suitable for implementing methods and systems according to the present disclosure. Computer system 500 may comprise, for example a computer running any of a number of operating systems. The above-described methods of the present disclosure may be implemented on the computer system 500 as stored program control instructions. Embodiments in accordance with the disclosure are not limited to any specific combination of hardware and/or software.

Computer system 500 includes processor 510, memory 520, storage 530, input/output structure(s) 540, and/or communications interface 555. One or more input/output devices 545 may include, for example, a touchscreen display. One or more busses 550 typically interconnect the components, 510, 520, 530, 540 and 555.

Processor 510 may include more than one processor or processing core. Processor 510 executes instructions in which embodiments of the present disclosure may comprise steps described in one or more of the Figures. Such instructions may be stored in memory 520 or storage 530. Data and/or information may be received and output using one or more input/output devices and/or communications interface 555. Hard-wired circuitry may be used in place of or in combination with processor 510.

Memory 520 stores information and instruction code used by processor 510 in carrying out the above described and/or other methods. Memory 520 may be implemented, for example, with volatile or non-volatile memory, including RAM, SRAM, DRAM, ROM, programmable ROM (PROM), flash memory, electronically programmable ROM (EPROM), electronically erasable programmable ROM (EEPROM), or any other suitable computer readable medium. Further, the implementation of memory 520 may include several possible embodiments, such as a single memory device or, alternatively, multiple memory devices communicatively connected or coupled together to form a shared or common memory. Still further, memory 520 may be integrated with other circuitry, such as processor 510 and/or portions of bus communications circuitry, among other possibilities.

Storage 530, which may include any combination of fixed or removable, volatile or non-volatile computer readable storage media, such as a magnetic or optical disk or flash memory card, can also be provided and coupled to bus 550 for storing data, instruction code, and/or content, such as video, e-books, music, or the like. Content may also be stored in memory 520.

Input/output structure(s) 540 may provide input/output operations for system 500. Input/output devices 545 utilizing these structures may include, for example, keyboards, displays, pointing devices, and audio devices, among others. In exemplary embodiments, system 500 may have the capability of recognizing voice commands.

As shown and may be readily appreciated by those skilled in the art, computer system 500 may be implemented in a desktop computer 560, a laptop computer 570, a hand-held computer 580, for example a tablet computer, personal digital assistant, e-reader, or smartphone, or one or more server computers which may, for example, comprise a “cloud” computer 590.

Computer system 500 may also include a communications interface 555 coupled to bus 550. Communications interface 555 provides a bidirectional, wired and/or wireless, data communications interface with a communications network 557. Network 557 may include both wired and wireless elements and may include, for example, satellite links, optical fiber, cable, and telephone lines, among other technologies.

Functions related to implementation of embodiments of the disclosure can be written into existing e-book reader products as one or more additional software modules, written in any suitable language for execution by computer system 500. In an exemplary embodiment, code for implementing one or more features of the disclosure is written in an XML or HTML structure, which advantageously allows the code to be web-based, and further may allow sharing of the features and the tabbing results for a book between multiple users.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, some or all of the elements may be implemented in a stored-program-controlled processor, e.g., a digital signal processor or a general purpose processor, which executes associated software, e.g., corresponding to one, or more, steps, which software may be embodied in any of a variety of suitable storage media. Further, the principles of the invention are applicable to various types of devices and systems, including personal computing systems, among others. In addition, as can be appreciated, user interactions with disclosed apparatus can take on a variety of forms depending on implementations of the apparatus. Thus for example, for apparatus with touchscreens, a wide variety of different gestures can be used to effect different user inputs, some of which have been described above by way of illustration and not limitation. It is therefore to be understood that numerous modifications may be made to the illustrative embodiments and that other arrangements may be devised without departing from the spirit and scope of the present invention.

1. A computer implemented method for managing supplementary information associated with an electronically stored document comprising the steps of:
receiving a request to associate a selected portion of the document with supplementary information;
associating the selected portion of the document with the supplementary information; and
displaying a representation of the supplementary information,
wherein the supplementary information includes at least one of a color, a user identity, a content location, and an additional information.

2. The method of claim 1, wherein the representation of the supplementary information includes a tab.

3. The method of claim 2 comprising:
selecting the tab; and
displaying the selected portion of the document and at least some of the supplementary information.

4. The method of claim 1, wherein the location includes at least one of a chapter, page number, section, heading, paragraph, column, row, and line number.

5. The method of claim 1, wherein the additional information includes user input.

6. The method of claim 1 comprising:
associating a plurality of portions of the electronic document with a plurality of respective supplementary information; and
displaying a plurality of tabs, each tab corresponding to one of the plurality of portions of the electronic document and associated supplementary information.

7. The method of claim 6 comprising:
organizing the plurality of tabs into two or more categories; and
displaying each tab using at least one of two or more colors corresponding to the two or more categories.

8. The method of claim 6 comprising:
selecting a subset of the plurality of tabs; and
displaying the portions of the electronic document associated with the selected subset of tabs.

9. The method of claim 1 comprising adding the supplementary information as metadata to the electronically stored document.

10. The method of claim 1, wherein the representation of the supplementary information that is displayed is interactive.

11. A computer implemented system for managing supplementary information associated with an electronically stored document said system being operable to:
receive a request to associate a selected portion of the document with supplementary information;
associate the selected portion of the document with the supplementary information; and
display a representation of the supplementary information,
wherein the supplementary information includes at least one of a color, a user identity, a location, and an additional information.

12. The system of claim 11, wherein the representation of the supplementary information includes a tab.

13. The system of claim 11, wherein the system is operable to:
select the tab; and
display the selected portion of the document and at least some of the supplementary information.

14. The system of claim 11, wherein the location includes at least one of a chapter, page number, section, heading, paragraph, column, row, and line number.

15. The system of claim 11, wherein the additional information includes user input.

16. The system of claim 11, wherein the system is operable to:
associate a plurality of portions of the electronic document with a plurality of respective supplementary information; and
display a plurality of tabs, each tab corresponding to one of the plurality of portions of the electronic document and associated supplementary information.

17. The system of claim 16, wherein the system is operable to:
organize the plurality of tabs into two or more categories; and
display each tab using at least one of two or more colors corresponding to the two or more categories.

18. The system of claim 16, wherein the system is operable to:
select a subset of the plurality of tabs; and
display the portions of the electronic document associated with the selected subset of tabs.

19. The system of claim 11, wherein the system is operable to add the supplementary information as metadata to the electronically stored document.

20. The system of claim 11, wherein the representation of the supplementary information that is displayed is interactive.
